(19) United States
(12) Patent Application Publication
(10) Pub. No.: US 2017/0188007 A1
(43) Pub. Date: Jun. 29, 2017

(54) MULTI-VIEW IMAGE TRANSMITTER AND RECEIVER AND METHOD OF MULTIPLEXING MULTI-VIEW IMAGE

(71) Applicant: Electronics and Telecommunications Research Institute, Daejeon-si (KR)

(72) Inventors: Seong Jun BAE, Daejeon-si (KR); Do Hyung KIM, Jeungpyeong-gun (KR)

(73) Assignee: Electronics and Telecommunications Research Institute, Daejeon-si (KR)

(21) Appl. No.: 15/233,116

(22) Filed: Aug. 10, 2016

(30) Foreign Application Priority Data
Dec. 23, 2015 (KR) 10-2015-0184892

(51) Int. Cl. H04N 13/00; H04N 13/02

(52) U.S. Cl. CPC H04N 13/0048; H04N 13/0059; H04N 13/0282

(57) ABSTRACT

A multi-view image transmitter and receiver, and a method of multiplexing a multi-view image. The multi-view image transmitter includes an image obtainer configured to obtain multi-view images that consist of source images of different views; a multiplexer configured to determine a multiplexing scheme according to multi-view image information that contains the number of views of the obtained multi-view images, and multiplex the source images with the determined multiplexing scheme; an encoder configured to encode a multiplexed image obtained by multiplexing the source images; and a transmitter configured to transmit the encoded multiplexed image.

### CROSS-REFERENCE TO RELATED APPLICATION(S)

This application claims the benefit under 35 USC §119(a) of Korean Patent Application No. 10-2015-0184892, filed on Dec. 23, 2015, in the Korean Intellectual Property Office, the entire disclosure of which is incorporated herein by reference for all purposes.

### BACKGROUND

1. Field

The following description relates to image processing, and more particularly, to 3-dimenstional multi-view image processing.

2. Description of Related Art

3-dimensional (3D) video services have been currently commercialized with a focus on a stereoscopic image consisting of two views. This approach is to present the right and left eyes with the same images as seen from the right and left directions to create a time difference between the two eyes, and to fuse the two images into one stereoscopic image to be represented. A stereoscopic image is evolving into a 3D multi-view image that has a number of views that vary depending on the viewpoints.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description relates to a multi-view image transmitter and receiver and a multiplexing method, whereby multi-view images, which consist of images of different views acquired at the same time instance, can be transmitted and received with the optimal quality even when the number of views of the multi-view images changes.

In one general aspect, there is provided a multi-view image transmitter including: an image obtainer configured to obtain multi-view images that consist of source images of different views; a multiplexer configured to determine a multiplexing scheme according to multi-view image information that contains the number of views of the obtained multi-view images, and multiplex the source images with the determined multiplexing scheme; an encoder configured to encode a multiplexed image obtained by multiplexing the source images; and a transmitter configured to transmit the encoded multiplexed image.

The image obtainer may acquire source images that were captured previously at different time instances or real-time source images at the same time instance.

The multiplexer may determine the multiplexing scheme using the number of source images of the multi-view images, a pixel resolution of the source images, and pixel resolution information of a transmittable multiplexed image, and multiplex the multi-view images with the determined multiplexing scheme.

The multiplexer may determine either a horizontal-direction multiplexing scheme or a vertical-direction multiplexing scheme according to the number of source images, a pixel resolution of the source images, and pixel resolution information of a multiplexed image.

The multiplexer may determine the multiplexing scheme such that the source images of different views can maintain their maximum sizes in the multiplexed image.

The multiplexer may include: an arranging part configured to arrange the source images and a multiplexed image; a calculation part configured to calculate the number of multiplexed source images with maximum size in a horizontal direction and the number of multiplexed source images with maximum size in a vertical direction, according to a pixel resolution of the source images and a pixel resolution of a multiplexed image; and a multiplexing part configured to multiplex the source images in a horizontal direction in response to a calculation result showing that the number of source images to be multiplexed is smaller than the number of multiplexed source images with maximum size in a horizontal direction, and multiplex the source images in a vertical direction in response to a calculation result showing that the number of source images to be multiplexed is smaller than the number of multiplexed source images with maximum size in a vertical direction.

The calculation part may calculate a normalized aspect ratio of a height for an image multiplexed in a horizontal direction by using an aspect ratio of the source image and a width of the multiplexed image, calculate a normalized aspect ratio of a height for an image multiplexed in a vertical direction by using the aspect ratio of the source image and a height of the multiplexed image, calculate the number of multiplexed source images with maximum size in a vertical direction by using the height of the multiplexed image and the normalized aspect ratio of a height for an image multiplexed in a horizontal direction, and calculate the number of multiplexed source images with maximum size in a vertical direction by using the height of the multiplexed image and the normalized aspect ratio of a height for an image multiplexed in a vertical direction.

The multiplexing part may calculate a target resolution of a source image of each view to be resampled for multiplexing, resample the source images with the calculated resolution, and multiplex the resampled source images in a horizontal direction or a vertical direction.

The multiplexing part may calculate a target horizontal resolution of the source image to be resampled for multiplexing by using a width of a multiplexed image, and calculate a target vertical resolution of the source image to be resampled for multiplexing by using a width and horizontal resolution of the source image and a width of a multiplexed image.

The multiplexing part may calculate a target horizontal resolution of a source image to be resampled for multiplexing by using a height of a multiplexed image, and calculate a target vertical resolution of the source image to be multiplexed for multiplexing by using the width and vertical resolution of the source image and a height of a multiplexed image.

In another general aspect, there is provided a multi-view image receiver including: a receiver configured to receive a multiplexed image; a decoder configured to decode the received multiplexed image; a demultiplexer configured to determine a demultiplexing scheme according to multi-view image information that contains the number of views of source images that form a decoded multiplexed image, and generate the source images by demultiplexing the multiplexed image with the determined scheme; and an outputter configured to output the source images generated by the demultiplexer.

In yet another general aspect, there is provided a method of multiplexing multi-view images including: obtaining multi-view images that consist of source images of different views; determining a multiplexing scheme according to multi-view image information that contains the number of views of the obtained multi-view images, and multiplexing the source images with the determined multiplexing scheme; and encoding a multiplexed image obtained by multiplexing the source images.

The multiplexing may include determining the multiplexing scheme using the number of source images of the multi-view images, a pixel resolution of the source images, and pixel resolution information of a transmittable multiplexed image, and multiplexes the multi-view images with the determined multiplexing scheme.

The multiplexing may include determining either a horizontal-direction multiplexing scheme or a vertical-direction multiplexing scheme according to the number of source images, a pixel resolution of the source images, and pixel resolution information of a multiplexed image.

The multiplexing may include determining the multiplexing scheme such that the source images of different views can maintain their maximum sizes in the multiplexed image.

The multiplexing may include: arranging the source images and a multiplexed image; calculating the number of multiplexed source images with maximum size in a horizontal direction and the number of multiplexed source images with maximum size in a vertical direction according to a pixel resolution of the source images and a pixel resolution of a multiplexed image; multiplexing the source images in a horizontal direction in response to a calculation result showing that the number of source images to be multiplexed is smaller than the number of multiplexed source images with maximum size in a horizontal direction; and multiplexing the source images in a vertical direction in response to a calculation result showing that the number of source images to be multiplexed is smaller than the number of multiplexed source images with maximum size in a vertical direction.

The calculating of the number of multiplexed source images may include: calculating a normalized aspect ratio of a height for an image multiplexed in a horizontal direction by using an aspect ratio of the source image and a width of the multiplexed image, and calculating a normalized aspect ratio of a height for an image multiplexed in a vertical direction by using the aspect ratio of the source image and a height of the multiplexed image; and calculating the number of multiplexed source images with maximum size in a vertical direction by using the height of the multiplexed image and the normalized aspect ratio of a height for an image multiplexed in a horizontal direction, and calculating the number of multiplexed source images with maximum size in a vertical direction by using the height of the multiplexed image and the normalized aspect ratio of a height for an image multiplexed in a vertical direction.

The multiplexing of the source images in a horizontal direction may include: calculating a target resolution of a source image of each view to be resampled for multiplexing; resampling the source images with the calculated resolution; and multiplexing the resampled source images in a horizontal direction.

The multiplexing of the source images in a vertical direction may include: calculating a target resolution of a source image of each view to be resampled for multiplexing; resampling the source images with the calculated resolution; and multiplexing the resampled source images in a vertical direction.

Other features and aspects will be apparent from the following detailed description, the drawings, and the claims.

### BRIEF DESCRIPTION OF THE DRAWINGS

FIG. 1 is a diagram illustrating a multi-view image transmission system according to an exemplary embodiment of the present invention.

FIG. 2 is a diagram illustrating the multiplexer of FIG. 1.

FIGS. 3 and 4 are diagrams illustrating examples of a multiplexed image and a source image according to an exemplary embodiment.

FIG. 5 is a diagram for explaining a horizontal multiplexing scheme.

FIG. 6 is a diagram for explaining a vertical multiplexing scheme.

FIG. 7 is a flowchart illustrating a method of multiplexing multi-view images according to an exemplary embodiment.

FIG. 8 is a flowchart illustrating in detail the horizontal-direction multiplexing process according to an exemplary embodiment.

FIG. 9 is a flowchart illustrating in detail the vertical-direction multiplexing process according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

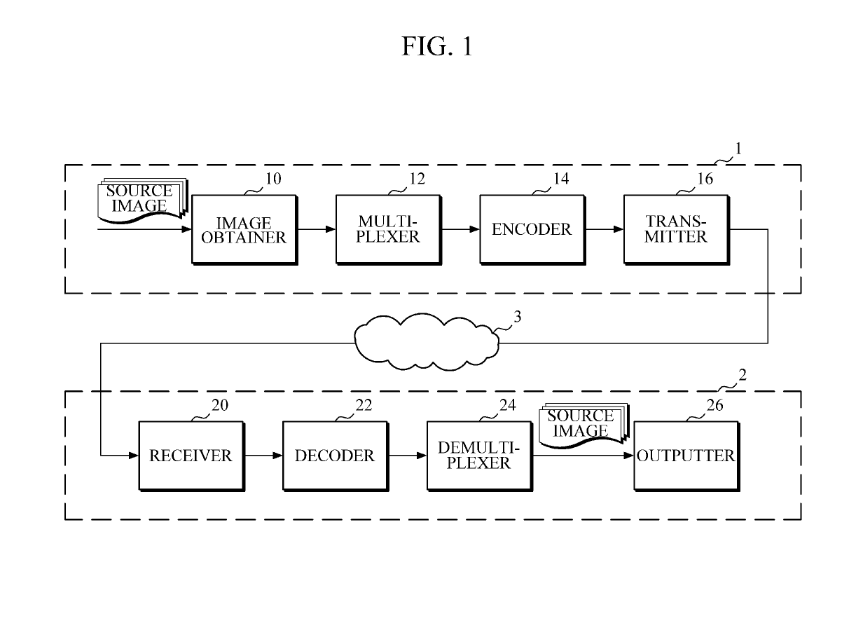

FIG. 1 is a diagram illustrating a multi-view image transmission system according to an exemplary embodiment of the present invention.

Referring to FIG. 1, the multi-view image transmission system includes a multi-view image transmitter 1, a multi-view image receiver 2, and a network 3.

The multi-view image transmitter 1 may be a server that obtains and transmits data, and the multi-view image receiver 2 may be a user terminal that receives and reproduces the data. In order for the multi-view image transmitter 1 to stream a multi-view image to the multi-view image receiver 2 over the network 3, compression of a number of images which are acquired at the same time and transmission of the compressed image are required. The present disclosure suggests an approach for transmitting multi-view images that are obtained with a varying number of views, which is not predetermined, to a remote receiver or receiving such multi-view images from a remote transmitter. In other words, the present disclosure relates to transmission and reception of a video consisting of multiple images that are acquired at the same instance, for example, a multi-view video streaming service to terminals that support a different number of views. According to the present disclosure, a multiplexed image, which is optimized to the number of views of terminals, can be transmitted and received, regardless of the number of views supported by the terminals, such as a multi-view TV that supports 4 views, and a mobile terminal that supports 2 views.

The present invention may be added to a streaming mechanism over a general network, that is, to a system which is summarized in image compression-transmission/reception-image decoding, thereby enabling a traditional streaming system to be reused. As shown in FIG. 1, a multiplexer 12 of the multi-view image transmitter 1 and a demultiplexer 24 of the multi-view image receiver 2 are added to an existing system.

According to the exemplary embodiment, the multi-view image transmitter 1 includes an image obtainer 10, the multiplexer 12, an encoder 14, and a transmitter 16. The multi-view image receiver 2 includes a receiver 20, a decoder 22, the demultiplexer 24, and an outputter 26.

The image obtainer 10 in the multi-view image transmitter 1 obtains multi-view images consisting of source images of different views. For example, multi-view images that consist of source image 1 of a scene containing object 1 captured from viewpoint 1, source image 2 from viewpoint 2, and source image 3 from viewpoint 3. The multiplexer 12 determines a multiplexing scheme to use according to the number of views of the source images obtained by the image obtainer 10, and multiplexes the source images with the determined scheme. At this time, the source images are multiplexed before being encoded by the encoder 14. The encoder 14 encodes the multiplexed image from the multiplexer 12, and the transmitter 16 transmits the resulting encoded multiplexed image to the multi-view image receiver 2 over the network 3.

The original multi-view images consisting of the source images have a predetermined number of images and pixel resolution, and a pixel resolution of a transmittable multiplexed image is determined. The multiplexer 12 uses the number of source images of the multi-view images, the pixel resolution of said multi-view images, and the pixel resolution of a transmittable multiplexed image to determine an optimal multiplexing scheme, and multiplexes the multi-view images with the determined multiplexing scheme to generate a resulting multiplexed image.

The generated multiplexed image from the multiplexer 12 is transmitted to the network 3, passing through the encoder 14 and the transmitter 16, and, in the same manner as the traditional streaming system, the multiplexed image passes through the network 3 and is received by the multi-view image receiver 2. The multiplexed image is recovered by the decoder 22 of the multi-view image receiver 2, and the recovered multi-view images are input to the demultiplexer 24, which recovers the source images of the original multi-view images from the multiplexed image in the reverse order of the multiplexing by the multiplexer 12. The recovered source images are ultimately output to a screen through the outputter 26.

Herein is described in detail the multiplexing whereby the multiplexer 12 generates a multiplexed image to be transmitted by optimizing the multi-view images in order to minimize the loss of information in the source images.

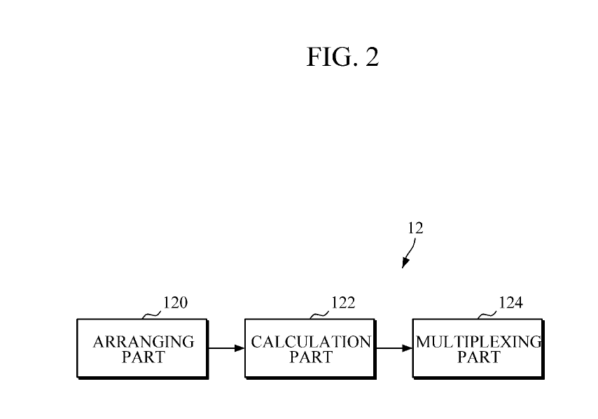

FIG. 2 is a diagram illustrating the multiplexer of FIG. 1.

Referring to FIG. 2, the multiplexer 12 includes an arranging part 120, a calculation part 122, and a multiplexing part 124.

The arranging part 120 arranges the source images and a multiplexed image. The arranging part 120 may arrange the source images and the multiplexed image in a landscape direction. The calculation part 122 calculates the number N^{H}(1) of multiplexed source images with the maximum size in a horizontal direction and the number N^{V}(1) of multiplexed source images with the maximum size in a vertical direction, according to the pixel resolution and aspect ratio (r_{Sw}×r_{Sh} and a_{Sw}×a_{Sh}) of source image and the pixel resolution and aspect ratio (r_{Mw}×r_{Mh} and a_{Mw}×a_{Mh}) of multiplexed image.

According to the exemplary embodiment, the calculation part 122 uses the aspect ratio

$$\frac{{a}_{sh}}{{a}_{sw}}$$

of the source image and the width a_{Mw} of the multiplexed image to calculate a normalized aspect ratio a_{SMh}^{H} of the height for the image multiplexed in a horizontal direction.

Also, the calculation part 122 uses the aspect ratio

$$\frac{{a}_{sh}}{{a}_{sw}}$$

of the source image and the height a_{Mh} of the multiplexed image to calculate a normalized aspect ratio a_{SMh}^{V} of the height for the image multiplexed in a vertical direction. Then, the calculation part 122 uses the height a_{Mh} of the multiplexed image and a normalized aspect ratio a_{SMh}^{H} of the height for the image multiplexed in a horizontal direction to calculate the number N^{H}(1) of multiplexed source images with the maximum size in a horizontal direction.

If the number of source images to be multiplexed (N^{S}) is smaller than the number of multiplexed source images with the maximum size in a horizontal direction (n^{N}(i) (N^{S}<n^{H}(i), the multiplexing part 124 multiplexes the source images in a horizontal direction. On the contrary, if N^{S} is smaller than the number of multiplexed source images with the maximum size in a vertical direction (n^{V}(i) (N^{S}<n^{V}(i), the multiplexing part 124 multiplexes the source images in a vertical direction.

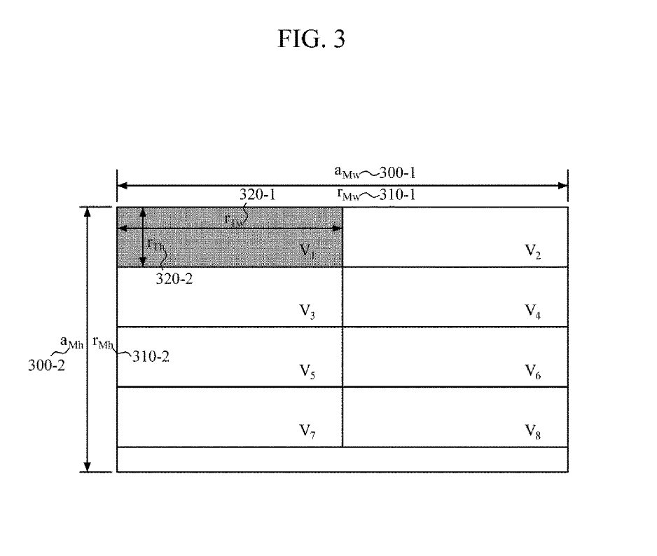

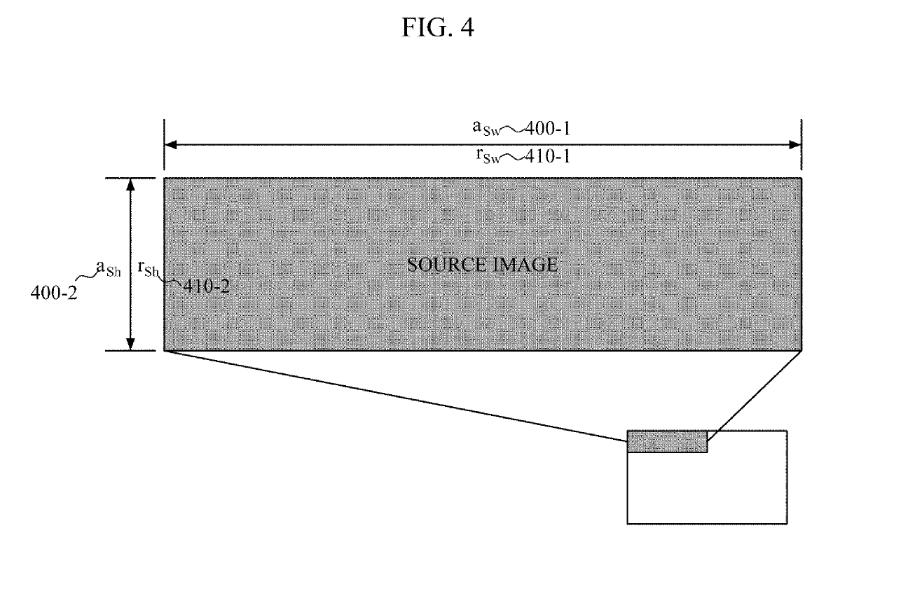

FIGS. 3 and 4 are diagrams illustrating examples of a multiplexed image and a source image according to an exemplary embodiment.

Referring to FIGS. 3 and 4, multi-view images consisting of source images have 8 views, and the multiplexer multiplexes the source images that correspond to the 8 views. The multiplexer multiplexes the source images with a pixel resolution of r_{Sw}×r_{Sh} into a multiplexed image with a pixel resolution of r_{Mw}×r_{Mh}.

The meaning of each descriptor in FIGS. 3 and 4 is as follows: a_{Sw}×a_{Sh} 400-1 and 400-2 is an aspect ratio of a source image (w×h), a_{Mw}×a_{Mh} is an aspect ratio of a multiplexed image (w×h). In addition, r_{Sw}×r_{Sh} 410-1 and 410-2 is a pixel resolution of a source image (w×h), and r_{Tw}×r_{Th} (w×h) 320-1 and 320-2 is a target resolution of a source image to be resampled for multiplexing.

The image shown in FIG. 4 is an original source image with a pixel resolution of r_{Sw}×r_{Sh} 410-1, 410-2 and an aspect ratio of a_{Sw}'a_{Sh} 400-1,400-2. The source image is multiplexed into an image with a pixel resolution of r_{Mw}×r_{Mh} 310-1,310-2 and an aspect ratio of a_{Mw}×a_{Mh} 300-1,300-2, which is shown in FIG. 3.

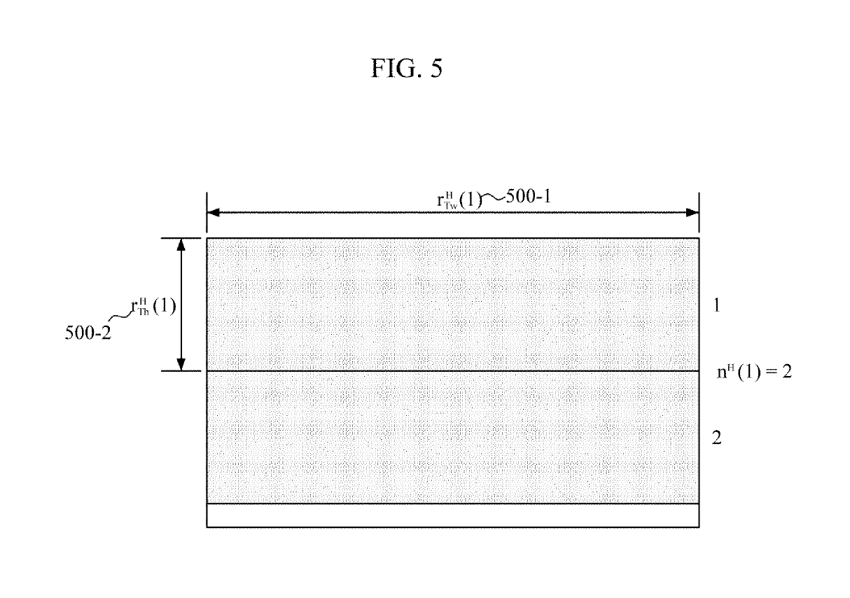

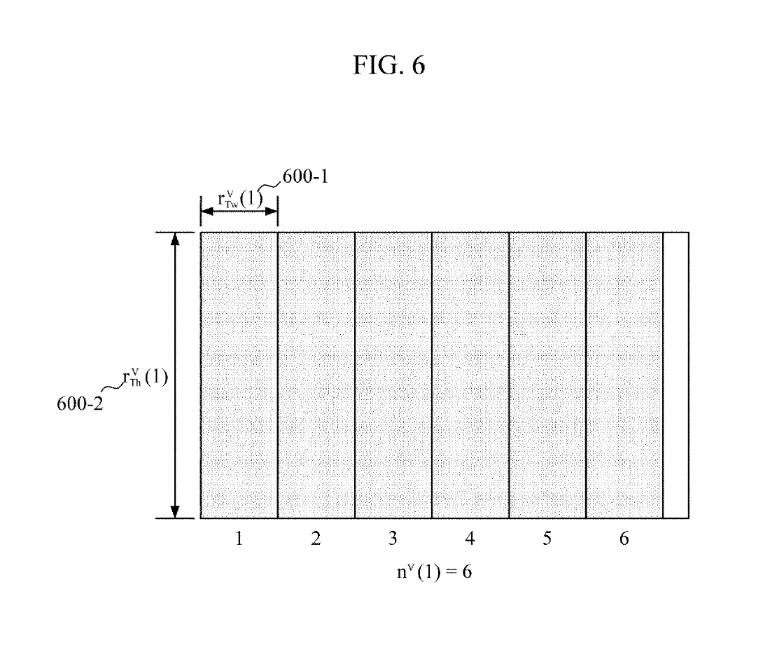

FIGS. 5 and 6 are diagrams for explaining multiplexing schemes according to an exemplary embodiment of the present disclosure, and specifically, FIG. 5 is a diagram for explaining a horizontal multiplexing scheme and FIG. 6 is a diagram for explaining a vertical multiplexing scheme.

Referring to FIGS. 5 and 6, a multiplexing scheme is decided as either a horizontal-direction multiplexing scheme or a vertical-direction multiplexing scheme according to the number of source images, a pixel resolution of the source images, and a pixel resolution of a multiplexed image. A multiplexing scheme that can maximize the size of a source image that corresponds to each view is the optimal scheme, and according to this condition, it is determined how the source images are multiplexed and arranged in the multi-view image.

The meaning of each descriptor in FIGS. 5 and 6 is as follows: r_{TW}^{H}(i)×r_{TW}^{H}(i) 500-1, 500-2 is a target resolution of a source image to be resampled for multiplexing in a horizontal direction. r_{TW}^{V}(i)×r_{Th}^{V}(i) 600-1,600-2 is a target resolution of a source image to be resampled for multiplexing in a vertical direction. N^{S} is the number of source images to be multiplexed, n^{H}(1) is the number of multiplexed source images with a maximum size in a horizontal direction, and n^{V}(1) is the number of multiplexed source images with a maximum size in a vertical direction.

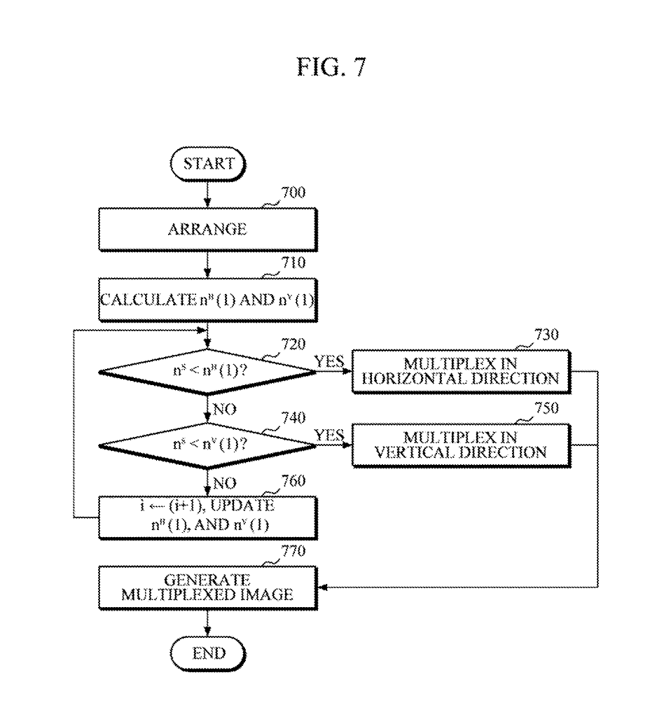

FIG. 7 is a flowchart illustrating a method of multiplexing multi-view images according to an exemplary embodiment.

Referring to FIGS. 1 and 7, the multiplexer of the multi-view image transmitter determines an optimal multiplexing scheme for multi-view images consisting of N^{S} source images, and generates a multiplexed image with the determined multiplexing scheme. The demultiplexer of the multi-view image receiver recovers the source images from the multiplexed image through the reverse order of multiplexing by the multiplexer.

According to the exemplary embodiment, the multi-view image transmitter arranges source images and a multiplexed image in a landscape direction, as depicted in 700. Then, the multi-view image transmitter calculates N^{H}(1), i.e., the number of multiplexed source images with the maximum size in a horizontal direction, and N^{V}(1), i.e., the number of multiplexed source images with the maximum size in a vertical direction, according to the pixel resolution and aspect ratio (r_{Sw}×r_{Sh} and a_{Sw}×a_{Sh}) of source image and the pixel resolution and aspect ratio (r_{Mw}×r_{Mh} and a_{Mw}×a_{Mh}) of multiplexed image, as depicted in 710. At this time, it is given that

$$\begin{matrix}a \begin{matrix}H \\ SMh\end{matrix} = \frac{{a}_{Sh} \cdot {a}_{Mw}}{{a}_{Sw}} , & a \begin{matrix}V \\ SMh\end{matrix} = \frac{{a}_{Sh} \cdot {a}_{Mh}}{{a}_{Sw}} , \\ {n}^{H} ( 1 ) = int ( \frac{{a}_{Mh}}{{a}_{SMh}^{H}} ) , and & {n}^{V} ( 1 ) = int ( \frac{{a}_{Mh}}{{a}_{SMh}^{V}} ) .\end{matrix}$$

a_{SMh}^{H} is a normalized source aspect ratio of the height for the multiplexed image in a horizontal direction, and a_{SMh}^{V} is a normalized source aspect ratio of the height for the multiplexed image in a vertical direction.

To be specific, a_{SMh}^{V} (the normalized source aspect ratio of the height for the multiplexed image in a horizontal direction) is calculated by using

$$\frac{{a}_{sh}}{{a}_{sw}}$$

(the aspect ratio of a source image) and the width a_{Mw} of the multiplexed image. Then, N^{H}(1), i.e., the number of multiplexed source images with the maximum size in a horizontal direction, is calculated using the height a_{Mh} of the multiplexed image and a_{SMh}^{H}. Accordingly, it is obtained that

$${n}^{H} ( 1 ) = int ( \frac{{a}_{Mh}}{{a}_{SMh}^{H}} ) .$$

Also, N^{V}(1), i.e., the number of multiplexed source images with the maximum size in a vertical direction is calculated by using the height a_{Mh} of the multiplexed image and a_{SMh}^{H}. As a result, it is obtained that

$${n}^{V} ( 1 ) = int ( \frac{{a}_{Mh}}{{a}_{SMh}^{V}} ) .$$

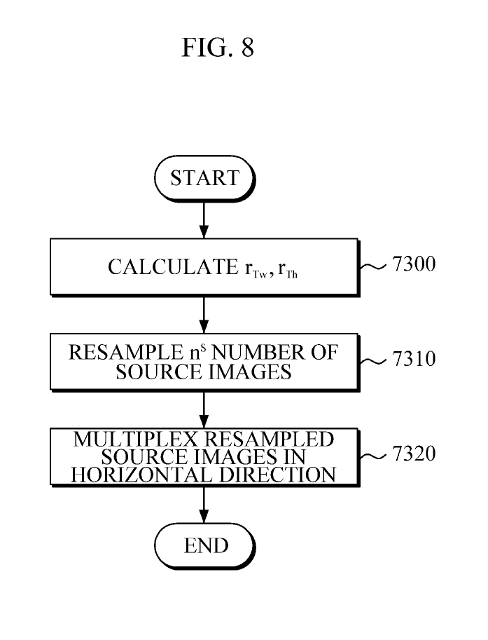

Then, the multi-view image transmitter determines whether the number of source images to be multiplexed (N^{S}) is greater smaller than the number of multiplexed source images with the maximum size in a horizontal direction (n^{N}(i)) (N^{S}<n^{H}(i)), as depicted in 720. If indeed N^{S}<n^{H}(i), the source images are multiplexed in a horizontal direction, and if N^{S}≧n^{H}(i), it is determined whether N^{S} is smaller than the number of multiplexed source images with the maximum size in a vertical direction (n^{V}(i)) (N^{S}<n^{V}(i)), as depicted in 740. The horizontal-direction multiplexing process will be described with reference to FIG. 8.

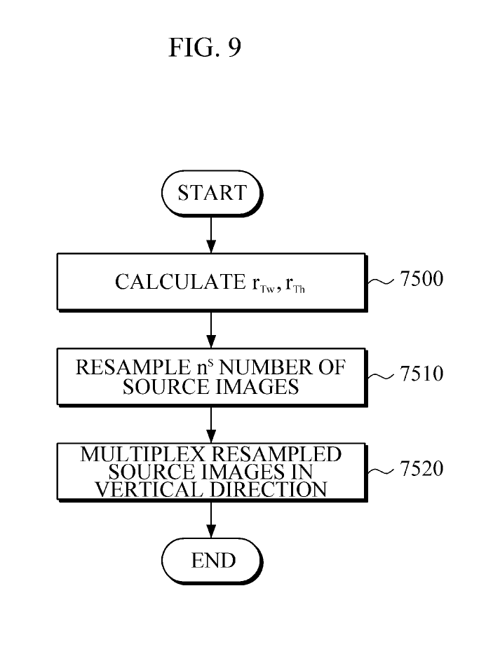

If indeed N^{S}<n^{V}(i), the source images are multiplexed in a vertical direction, as depicted in 750, and if N^{S}≧n^{V}(i), the multi-view image transmitter increases i by 1 (i←i1), while updating N^{H}(i) and N^{V}(i) (n^{H}(i)←4n^{H}(i-1) and n_{V}(i)←4n^{V}(i-1)), as depicted in 760, and repeats the aforesaid operations 720, 730, 740, and 750. The vertical-direction multiplexing process will be described with reference to FIG. 9.

Ultimately, multiple source images are multiplexed into a single multiplexed image through the horizontal-direction multiplexing 730 or the vertical-direction multiplexing 750, as depicted in 770. The multiplexed image is encoded by an encoder, such as an H.264 encoder, and streamed to the network. i denotes an index for i-th smaller resolution. For example, r_{TW}^{H}(2)=1/2r_{TW}^{H}(1).

FIG. 8 is a flowchart illustrating in detail the horizontal-direction multiplexing process according to an exemplary embodiment.

Referring to FIG. 8, the multi-view image transmitter calculates a target resolution r_{Tw}×r_{Th} of a source image of each view to be resampled for multiplexing, as depicted in 7300. For example, the multi-view image transmitter calculates the target horizontal resolution r_{Tw} of a source image to be resampled for multiplexing by using the width r_{Tw} of a multiplexed image, and calculates the vertical resolution r_{Th} of a source image to be resampled for multiplexing by is using the width r_{Sw} and horizontal resolution r_{Sh} of a source image and the width a_{Mw} of a multiplexed image. Accordingly, it is obtained that

$$r \begin{matrix}H \\ TW\end{matrix} ( i ) = \frac{{r}_{MW}}{2 i} and r \begin{matrix}H \\ Th\end{matrix} ( i ) = \frac{{r}_{Sh} \cdot {a}_{MW}}{2 i \cdot {a}_{SW}} .$$

Then, N^{S} number of source images are resampled at a resolution of r_{Tw}×r_{Th}, as depicted in 7310, and the resampled source images are multiplexed in a horizontal direction, as depicted in 7320.

FIG. 9 is a flowchart illustrating in detail the vertical-direction multiplexing process according to an exemplary embodiment.

Referring to FIG. 9, the multi-view image transmitter calculates a target resolution r_{Tw}×r_{Th} of a source image of each view to be resampled for multiplexing, as depicted in 7500. For example, the multi-view image transmitter calculates the target horizontal resolution r_{Tw} for multiplexing by using the height r_{Mh} of a multiplexed image, and calculates the target vertical resolution r_{Th} for multiplexing by using the width and vertical resolution r_{SW} and r_{Sh} of a source image and the height a_{Mh} of a multiplexed image. Accordingly, it is obtained that

$$r \begin{matrix}V \\ TW\end{matrix} ( i ) = \frac{{r}_{Mh}}{2 i} and \qquad r \begin{matrix}V \\ Th\end{matrix} ( i ) = \frac{{r}_{Sh} \cdot {a}_{Mh}}{2 i \cdot {a}_{SW}} .$$

Thereafter, N^{S} number of source images are resampled at a resolution of r_{Tw}×r_{Th}, as depicted in 7510, and the resampled source images are multiplexed in a vertical direction, as depicted in 7520.

According to the above exemplary embodiments, it is possible to maintain image arrangement and image quality at an optimal level when multi-view images that consist of multiple images acquired at the same time instance, for example, a multi-view video streaming service to terminals that support a different number of views, is streamed to a remote receiver. Further, it is possible to use, without modification, a streaming mechanism over a general network, i.e., a traditional streaming system which is summarized in image compression-transmission/reception-image decoding.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-view image transmitter comprising:
an image obtainer configured to obtain multi-view images that consist of source images of different views;
a multiplexer configured to determine a multiplexing scheme according to multi-view image information that contains the number of views of the obtained multi-view images, and multiplex the source images with the determined multiplexing scheme;
an encoder configured to encode a multiplexed image obtained by multiplexing the source images; and
a transmitter configured to transmit the encoded multiplexed image.

2. The multi-view image transmitter of claim 1, wherein the image obtainer acquires source images that were captured previously at different time instances or real-time source images at the same time instance.

3. The multi-view image transmitter of claim 1, wherein the multiplexer determines the multiplexing scheme using the number of source images of the multi-view images, a pixel resolution of the source images, and pixel resolution information of a transmittable multiplexed image, and multiplexes the multi-view images with the determined multiplexing scheme.

4. The multi-view image transmitter of claim 1, wherein the multiplexer determines either a horizontal-direction multiplexing scheme or a vertical-direction multiplexing scheme according to the number of source images, a pixel resolution of the source images, and pixel resolution information of a multiplexed image.

5. The multi-view image transmitter of claim 1, wherein the multiplexer determines the multiplexing scheme such that the source images of different views can maintain their maximum sizes in the multiplexed image.

6. The multi-view image transmitter of claim 1, wherein the multiplexer comprises an arranging part configured to arrange the source images and a multiplexed image, a calculation part configured to calculate the number of multiplexed source images with maximum size in a horizontal direction and the number of multiplexed source images with maximum size in a vertical direction, according to a pixel resolution of the source images and a pixel resolution of a multiplexed image, and a multiplexing part configured to multiplex the source images in a horizontal direction in response to a calculation result showing that the number of source images to be multiplexed is smaller than the number of multiplexed source images with maximum size in a horizontal direction, and multiplex the source images in a vertical direction in response to a calculation result showing that the number of source images to be multiplexed is smaller than the number of multiplexed source images with maximum size in a vertical direction.

7. The multi-view image transmitter of claim 6, wherein the calculation part calculates a normalized aspect ratio of a height for an image multiplexed in a horizontal direction by using an aspect ratio of the source image and a width of the multiplexed image, calculates a normalized aspect ratio of a height for an image multiplexed in a vertical direction by using the aspect ratio of the source image and a height of the multiplexed image, calculates the number of multiplexed source images with maximum size in a vertical direction by using the height of the multiplexed image and the normalized aspect ratio of a height for an image multiplexed in a horizontal direction, and calculates the number of multiplexed source images with maximum size in a vertical direction by using the height of the multiplexed image and the normalized aspect ratio of a height for an image multiplexed in a vertical direction.

8. The multi-view image transmitter of claim 6, wherein the multiplexing part calculates a target resolution of a source image of each view to be resampled for multiplexing, resamples the source images with the calculated resolution, and multiplexes the resampled source images in a horizontal direction or a vertical direction.

9. The multi-view image transmitter of claim 8, wherein the multiplexing part calculates a target horizontal resolution of the source image to be resampled for multiplexing by using a width of a multiplexed image, and calculates a target vertical resolution of the source image to be resampled for multiplexing by using a width and horizontal resolution of the source image and a width of a multiplexed image.

10. The multi-view image transmitter of claim 8, wherein the multiplexing part calculates a target horizontal resolution of a source image to be resampled for multiplexing by using a height of a multiplexed image, and calculates a target vertical resolution of the source image to be multiplexed for multiplexing by using the width and vertical resolution of the source image and a height of a multiplexed image.

11. A multi-view image receiver comprising:
a receiver configured to receive a multiplexed image;
a decoder configured to decode the received multiplexed image;
a demultiplexer configured to determine a demultiplexing scheme according to multi-view image information that contains the number of views of source images that form a decoded multiplexed image, and generate the source images by demultiplexing the multiplexed image with the determined scheme; and
an outputter configured to output the source images generated by the demultiplexer.

12. A method of multiplexing multi-view images comprising:
obtaining multi-view images that consist of source images of different views;
determining a multiplexing scheme according to multi-view image information that contains the number of views of the obtained multi-view images, and multiplexing the source images with the determined multiplexing scheme; and
encoding a multiplexed image obtained by multiplexing the source images.

13. The method of claim 12, wherein the multiplexing comprises determining the multiplexing scheme using the number of source images of the multi-view images, a pixel resolution of the source images, and pixel resolution information of a transmittable multiplexed image, and multiplexes the multi-view images with the determined multiplexing scheme.

14. The method of claim 12, wherein the multiplexing comprises determining either a horizontal-direction multiplexing scheme or a vertical-direction multiplexing scheme according to the number of source images, a pixel resolution of the source images, and pixel resolution information of a multiplexed image.

15. The method of claim 12, wherein the multiplexing comprises determining the multiplexing scheme such that the source images of different views can maintain their maximum sizes in the multiplexed image.

16. The method of claim 12, wherein the multiplexing comprises:
arranging the source images and a multiplexed image,
calculating the number of multiplexed source images with maximum size in a horizontal direction and the number of multiplexed source images with maximum size in a vertical direction according to a pixel resolution of the source images and a pixel resolution of a multiplexed image,
multiplexing the source images in a horizontal direction in response to a calculation result showing that the number of source images to be multiplexed is smaller than the number of multiplexed source images with maximum size in a horizontal direction, and
multiplexing the source images in a vertical direction in response to a calculation result showing that the number of source images to be multiplexed is smaller than the number of multiplexed source images with maximum size in a vertical direction.

17. The method of claim 16, wherein the calculating of the number of multiplexed source images comprises:
calculating a normalized aspect ratio of a height for an image multiplexed in a horizontal direction by using an aspect ratio of the source image and a width of the multiplexed image, and calculating a normalized aspect ratio of a height for an image multiplexed in a vertical direction by using the aspect ratio of the source image and a height of the multiplexed image, and
calculating the number of multiplexed source images with maximum size in a vertical direction by using the height of the multiplexed image and the normalized aspect ratio of a height for an image multiplexed in a horizontal direction, and calculating the number of multiplexed source images with maximum size in a vertical direction by using the height of the multiplexed image and the normalized aspect ratio of a height for an image multiplexed in a vertical direction.

18. The method of claim 16, wherein the multiplexing of the source images in a horizontal direction comprises:
calculating a target resolution of a source image of each view to be resampled for multiplexing,
resampling the source images with the calculated resolution, and
multiplexing the resampled source images in a horizontal direction.

19. The method of claim 16, wherein the multiplexing of the source images in a vertical direction comprises:
calculating a target resolution of a source image of each view to be resampled for multiplexing,
resampling the source images with the calculated resolution, and
multiplexing the resampled source images in a vertical direction.
